(19) United States
(12) Patent Application Publication
(10) Pub. No.: US 2004/0020953 A1
(43) Pub. Date: Feb. 5, 2004

(54) Motorcycle luggage rack system

(76) Inventor: Ed Kopidlansky, Cary, IL (US)

Correspondence Address: Kevin D. Erickson, Pauley Petersen Kinne & Erickson, Suite 365, 2800 West Higgins Road, Hoffman Estates, IL, 60195, US

(21) Appl. No.: 10/633,736

(22) Filed: Aug. 4, 2003

Related U.S. Application Data
(60) Provisional application No. 60/400,961, filed on Aug. 2, 2002.

(51) Int. Cl. B62J 7/00; B62J 9/00; B62J 11/00

(52) U.S. Cl. 224/413; 224/423; 224/427

(57) ABSTRACT

A luggage rack for a motorcycle includes a frame assembly, the frame assembly removably mounted to upright bars with respect to a seat of the motorcycle, and a top plate, the top plate interchangeable with at least one other top plate having a different configuration, and the top plate removably attached with respect to the frame assembly.

### CROSS REFERENCE TO RELATED APPLICATIONS

This application claims the benefit of U.S. Provisional Application No. 60/400,961, filed Aug. 2, 2002.

### FIELD OF THE INVENTION

This invention relates to the field of motorcycle accessories, and more specifically to motorcycle luggage racks.

### BACKGROUND OF THE INVENTION

Luggage racks are common motorcycle accessories, and are usually purchased by a motorcycle owner to increase the utility of the motorcycle. However, utility is only one desirable attribute of a luggage rack. Often, the aesthetic qualities of a luggage rack are equally, if not more, important to the motorcycle owner. However, typical luggage racks not only lack decorative attributes, but also require permanent attachment, which further detracts from the overall appeal of the motorcycle.

Accordingly, a need exists for a new and improved motorcycle luggage rack that is easily mounted or removed from a motorcycle, and serves as a functional luggage carrier and/or as a decorative motorcycle accessory.

### SUMMARY OF THE INVENTION

The present invention relates to a motorcycle luggage rack for mounting to upright bars of a motorcycle. The luggage rack preferably includes a frame assembly and a top plate. The frame assembly is preferably mounted with respect to a seat of the motorcycle.

According to one preferred embodiment of this invention, the top plate is preferably removably and interchangeably secured to the frame assembly. The top plate may be designed to function as a luggage carrier and/or as a decorative motorcycle accessory. Top plate decorative designs may include, but are not limited to, a skull design, a Maltese cross design, a flame design and one or more functional luggage rack designs. As such one or more primarily functional or decorative top plates may be interchangeably attached to the motorcycle depending upon the preferences of the rider.

The frame assembly according to one preferred embodiment of this invention preferably includes a cover plate, a lock plate, at least one bracket and at least one elongated fastener. The cover plate and the lock plate preferably rest on sleeve upper edges of female sleeves which hold the upright bars in place. Such placement of the cover plate and the lock plate prevents downward movement of the frame assembly. According to one preferred embodiment of this invention, the cover plate and the lock plate form a sandwich-type configuration around the upright bars.

The frame assembly according to another preferred embodiment of this invention includes a lock plate, at least one bracket, at least one clamping block, at least one bracket fastener and at least one block fastener. The frame assembly may include two clamping blocks, each of which is preferably positioned against one upright bar. The clamping blocks are preferably coupled to the lock plate, which may be positioned on the opposite side of the upright bars, with a plurality of block fasteners. The plurality of block fasteners may replace existing motorcycle hardware which holds the upright bars in place.

According to another preferred embodiment of this invention, the clamping blocks preferably form U-shaped channels around the upright bars against which they are positioned. The clamping blocks, according to one preferred embodiment of this invention, are preferably positioned at an angle that corresponds to the angle at which the upright bars are positioned relative to vertical.

According to a preferred embodiment of this invention, the luggage rack may have a protective and/or decorative luggage rack cover. The luggage rack cover, according to one preferred embodiment, preferably comprises a sheath designed to fit around one or more top plates according to this invention. The luggage rack cover may further include a flap that is preferably foldable around the cover plate and at least one cover fastener fastening the flap to the sheath. The luggage rack cover may be made of leather or any other suitable material and may include decorative designs and/or ornaments.

It is therefore an object of this invention to provide a luggage rack that is easily mounted to or removed from a motorcycle.

It is a further object of this invention to provide a luggage rack that serves as a functional luggage carrier and/or as a decorative motorcycle accessory.

It is another object of this invention to provide a luggage rack that removably accommodates one or more interchangeable top plates having different functional and/or decorative configurations.

It is also another object of this invention to provide a luggage rack cover that serves as a protective and/or decorative accessory for a motorcycle luggage rack.

The foregoing and other features and advantages of the present invention will become further apparent from the following detailed description of the presently preferred embodiments, read in conjunction with the accompanying drawings. The detailed description and drawings are intended to illustrate the present invention rather than limit the scope of the present invention as defined by the appended claims and equivalents of the appended claims.

### BRIEF DESCRIPTION OF THE DRAWINGS

The present invention can be better understood with reference to the following drawings. It should be noted that the drawings are not necessarily to scale, emphasis instead being placed upon clearly illustrating principles of the present invention.

FIG. 1 is a side perspective view of a luggage rack according to one preferred embodiment of this invention;

FIG. 2 is a top view of the luggage rack shown in FIG. 1;

FIG. 3 is a side view of the luggage rack shown in FIG. 1;

FIG. 4 is a front view of a lock plate according to one preferred embodiment of this invention;

FIG. 5 is a back view of a luggage rack according to one preferred embodiment of this invention;

FIG. 6 is a front view of a luggage rack according to one preferred embodiment of this invention;

FIG. 7 is a top view of the luggage rack show in FIG. 6;

FIG. 8a is a top view of a top plate according to one preferred embodiment of this invention;

FIG. 8b is a top view of a top plate according to one preferred embodiment of this invention;

FIG. 8c is a top view of a top plate according to one preferred embodiment of this invention.

FIG. 8d is a top view of a top plate according to one preferred embodiment of this invention;

FIG. 8e is a top view of a top plate according to one preferred embodiment of this invention; and

FIG. 9 is a bottom view of a luggage rack cover according to one preferred embodiment of this invention.

### DETAILED DESCRIPTION OF PREFERRED EMBODIMENTS

FIGS. 1-9 illustrate preferred embodiments of motorcycle luggage rack 45 in accordance with the present invention.

FIGS. 1-4 show one preferred embodiment of this invention. According to this preferred embodiment of motorcycle luggage rack 45, luggage rack 45 preferably comprises frame assembly 55 and top plate 40. Frame assembly 55 is preferably mounted with respect to seat 75 of a motorcycle, directly onto upright bars 120 (“sissy bar”) of the motorcycle. In one preferred embodiment of this invention, frame assembly 55 as shown in FIG. 1 preferably comprises cover plate 100, lock plate 20, at least one bracket 30 and at least one elongated fastener 50. Cover plate 100 and lock plate 20, when positioned with respect to upright bars 120, preferably form a sandwich-type configuration around upright bars 120. Cover plate 100 is preferably positioned against upright bars 120 from a seat side of the motorcycle, and lock plate 20 is preferably positioned on the side of upright bars 120 opposite cover plate 100. Upright bars 120 are thereby preferably positioned between cover plate 100 and lock plate 20.

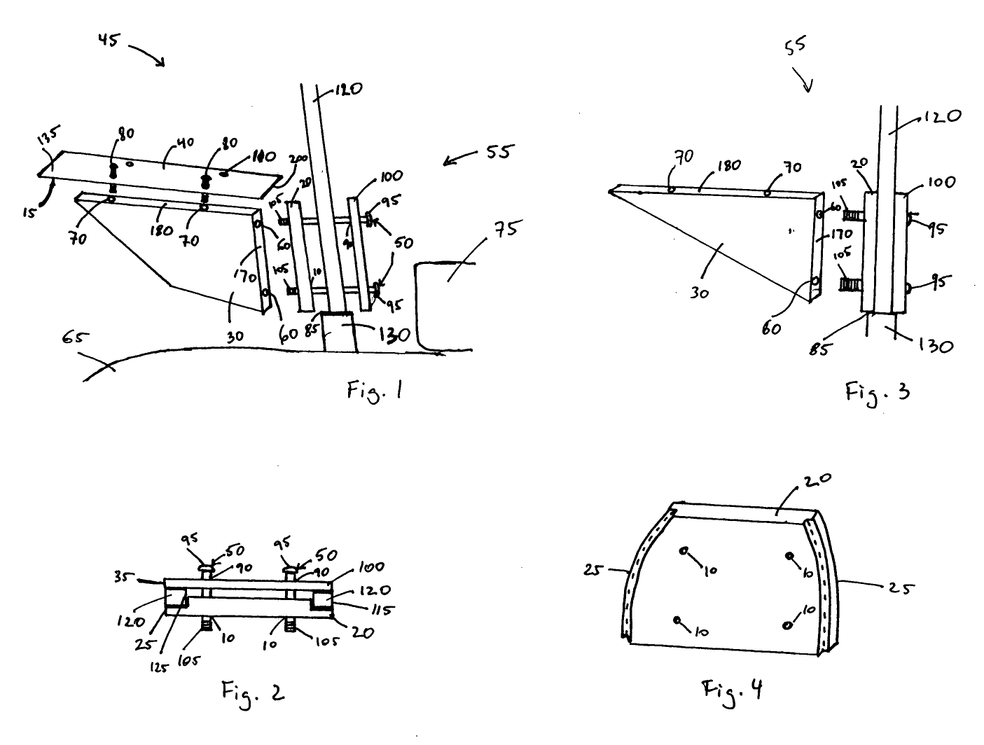

According to a preferred embodiment of this invention as illustrated in FIG. 3, cover plate 100 and lock plate 20 rest on sleeve upper edges of female sleeves 130 which hold upright bars 120 in place. Such placement of cover plate 100 and lock plate 20 in this preferred embodiment prevents downward movement of frame assembly 55 thus enabling frame assembly 55 to stay in place. This luggage rack 45, illustrated in FIG. 1, is preferably used with motorcycles that have upright bars 120 inserted into female sleeves 130 or other support members. As shown in FIG. 3, in one preferred embodiment of this invention, cover plate 100 and lock plate 20 are preferably designed to rest on sleeve upper edges 85 of female sleeves 130 or other support members.

According to one preferred embodiment of this invention, shown in FIGS. 1-4, cover plate 100 preferably includes at least one cover plate aperture 90 which preferably corresponds with at least one lock plate aperture 10 within lock plate 20. These corresponding apertures are preferably designed to accommodate at least one removable elongated fastener 50 with which cover plate 100 and lock plate 20 are secured together. According to one preferred embodiment of this invention as shown in FIGS. 1-3, frame assembly 55 preferably comprises plurality of elongated fasteners 50. Elongated fasteners 50 preferably extend away from cover plate 100 and toward a rear of the motorcycle as illustrated in FIG. 1. Elongated fasteners 50 may include heads 95 that are preferably positioned on a seat side of cover plate 100, and elongated fasteners 50 preferably extend through cover plate 100. Elongated fasteners 50 may include ends 105 opposite heads 95 that preferably extend beyond lock plate 20 as illustrated in FIG. 1-3.

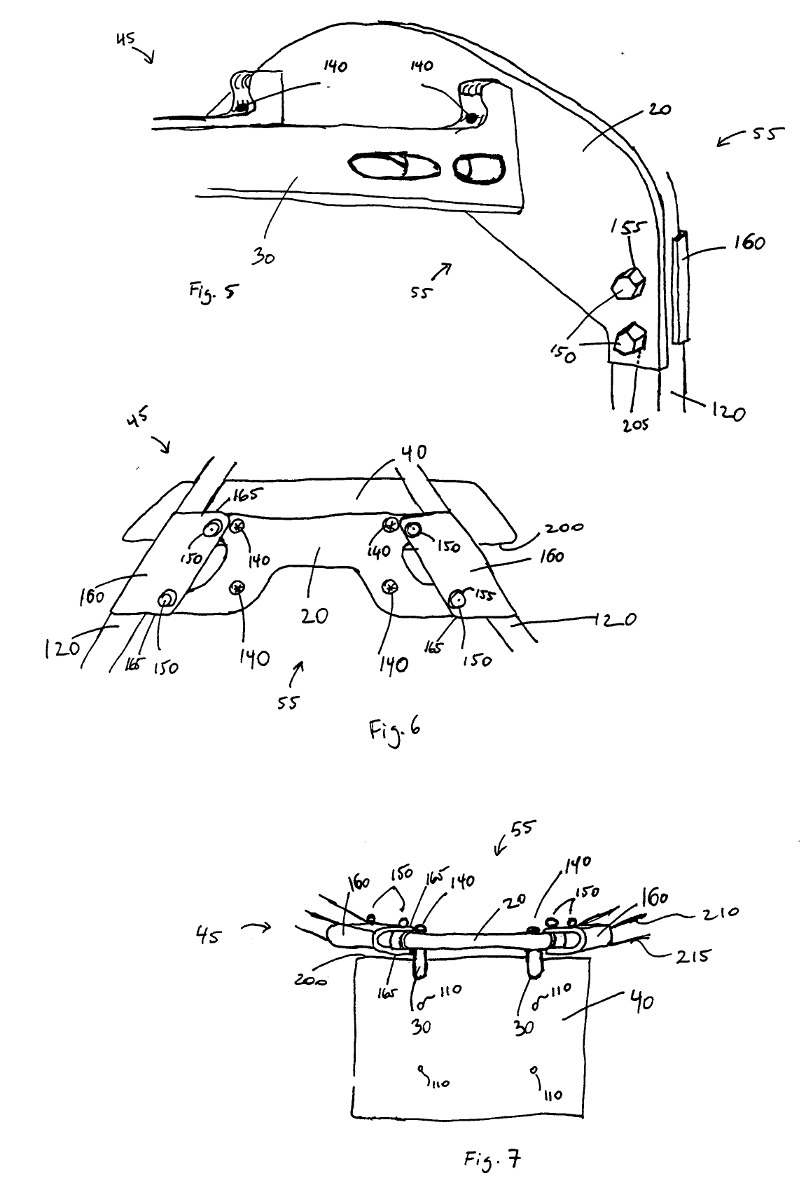

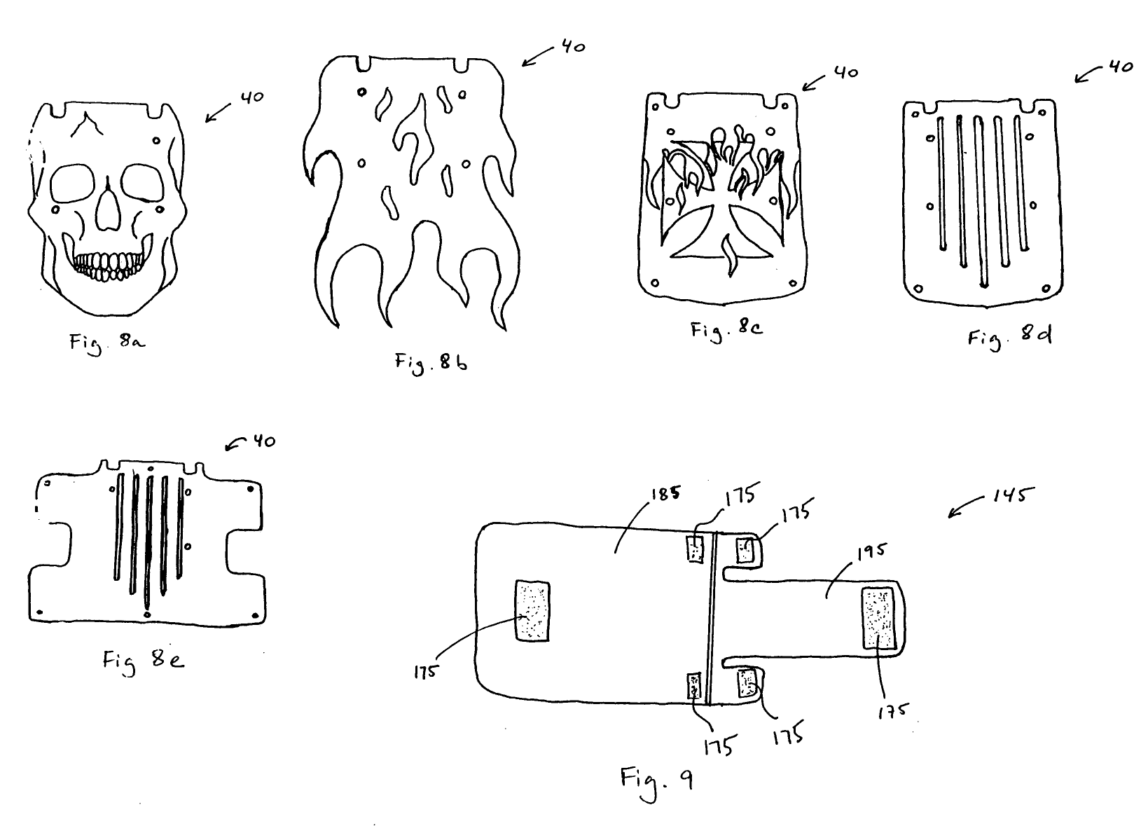

According to one preferred embodiment of this invention as shown in FIG. 4, lock plate 20 and cover plate 100 are designed so that lock plate side edges 25 and cover plate side edges 35 are generally flush with outside bar edges 115 of upright bars 120. Moreover, lock plate 20 as illustrated in FIG. 2 and FIG. 4 may have a portion of its thickness milled away along lock plate side edges 25 so that lock plate 20 at least partially fits between inside bar edges 125 of upright bars 120. Alternatively, lock plate 20 may completely fill the area between upright bars 120 and cover plate 100. Such alternative configuration increases strength and rigidity of the frame assembly.

In one preferred embodiment of this invention, frame assembly 55 comprises at least one bracket 30. Brackets 30 are preferably used to support a load of luggage rack 45 and, more specifically, support top plates 40 that, in turn, support the load. In a preferred embodiment of this invention, shown in FIG. 1, frame assembly 55 preferably comprises two brackets 30, each preferably comprising bracket side edge 170, bracket upper edge 180, one or more side threaded apertures 60 within bracket side edge 170 and one or more upper threaded apertures 70 within bracket upper edge 180. In one preferred embodiment of this invention, shown in FIG. 1, brackets 30 are preferably removably attached with respect to lock plate 20. Brackets 30 are preferably removably secured to lock plate 20 with elongated fasteners 50 extending from lock plate 20 as shown in FIG. 1. Elongated fasteners 50 are preferably tightened into side threaded apertures 60 within bracket side edges 170 of brackets 30. Brackets 30, when attached to lock plate 20, preferably extend away from seat 75 of the motorcycle and suspend over rear fender 65 of the motorcycle as shown in FIG. 1.

In one preferred embodiment of this invention, top plate 40 may be removably secured to brackets 30 through top surface 135 of top plate 40 with at least one top fastener 80 as shown in FIG. 1. In one preferred embodiment of this invention, shown in FIG. 1, top plate is preferably secured to brackets 30 with four top fasteners 80. Top fasteners 80 preferably extend through top surface 135 of top plate 40 and into bracket upper edges 180 of brackets 30. Top plate 40 may be attached to frame assembly 55 by extending top fasteners 80 from top surface 135 of top plate 40 into upper threaded apertures 70 within bracket upper edges 180 of brackets 30. Top plate 40, when attached to brackets 30, preferably suspends over rear fender 65 of the motorcycle. Alternatively, top plate 40 my be attached to brackets 30 with any method, which may or may not involve tools and/or fasteners, known to those having ordinary skill in the art.

Top plate 40 is preferably designed to function as a luggage carrier and/or as a decorative motorcycle accessory. As shown in FIGS. 8a-8e, top plates 40 may have different sizes, designs, decorative motifs and styles to serve different purposes. In one preferred embodiment of this invention, top plate 40 may have a design of a skull as shown in FIG. 8a. In another preferred embodiment of this invention, top plate 40 may have a design of a flame as shown in FIG. 8b or a Maltese cross as shown in FIG. 8c. In yet another embodiment of this invention, top plate 40 may have a more functional rather than decorative design, shown in FIG. 8d and FIG. 8e, or any other suitable design. Top plates 40 are preferably easily interchangeable, and they are preferably interchangeable across different motorcycle models and/or luggage rack 45 embodiments according to this invention. Brackets 30 may also have different sizes, shapes and designs to match one or more decorative and/or functional features of top plate 40 to create a distinctive, decorative motorcycle accessory and/or functional luggage rack 45.

According to a preferred embodiment of this invention, luggage rack 45 my be made of billet aluminum or any other suitable material, and it may have a chrome or any other suitable finish. In addition to being versatile in utility and aesthetics, luggage rack 45 can easily and quickly be mounted to or removed from the motorcycle preferably without any, or only minimal, adjustments or removal of hardware or accessories already existing on the motorcycle.

Referring to FIG. 5, an alternate embodiment of the present invention is illustrated. Luggage rack 45 as illustrated in FIG. 5 preferably comprises frame assembly 55 and top plate 40. Frame assembly 55 preferably includes at least one bracket 30, lock plate 20, at least one clamping block 160 and at least one block fastener 150. Frame assembly may further comprise at least one bracket fastener 140. According to one preferred embodiment of this invention, shown in FIG. 5, frame assembly 55 preferably includes four bracket fasteners 150, four block fasteners 150, two brackets 30 and two clamping blocks 160. Clamping blocks 160 are preferably positioned against upright bars 120 from a seat side of the motorcycle; one clamping block 160 against each upright bar 120. Lock plate 20 is positioned on the opposite side of upright bars 120 with respect to clamping blocks 160. Similar to the above-described embodiment, clamping blocks 160 and lock plate 20 form a sandwich-type configuration around upright bars 120. Lock plate 20 preferably includes at least one lock plate aperture 10 which may correspond with at least one clamping block aperture 155.

This embodiment of the current invention is preferred for motorcycles that lack female sleeves 130 that hold upright bars 120 in place, but, instead, include bottom ends of upright bars that are bolted to some fixed part of the motorcycle. To attach frame assembly 55 to the motorcycle, existing bolts that hold upright bars 120 in place may be replaced with block fasteners 150 that couple lock plate 20 and clamping blocks 160 together. Frame assembly 55 is preferably attached to upright bars 120 by, first, positioning lock plate 20 and two clamping blocks 160 with respect to upright bars 120 so that clamping block apertures 155 and lock plate apertures 10 align with existing upright bar apertures 205 in upright bars 120, and, second, tightening block fasteners 150 into thus aligned upright bar apertures 205, lock plate apertures 10 and clamping block apertures 155.

According to this preferred embodiment of the present invention, brackets 30 are preferably removably attached with respect to lock plate 20 as illustrated in FIG. 5. Brackets 30 are preferably removably secured to lock plate 20 with at least one bracket fastener 140. Bracket fasteners 140 are preferably tightened into side threaded apertures 60 within bracket side edges 170 of brackets 30. Brackets 30, when attached to lock plate 20, preferably extend away from seat 75 of the motorcycle and suspend over rear fender 65 of the motorcycle.

Top plate 40 may be removably secured to brackets 30 through top surface 135 of top plate 40 using at least one top fastener 80. According to one preferred embodiment of this invention, top plate 40 is preferably removably fastened to at least one bracket 30 with a plurality of top fasteners 80. Top fasteners 80 may extend through top surface 135 of top plate 40 and into bracket upper edges 180 of brackets 30. Top plate 40 may be attached to frame assembly 145 by tightening top fasteners 80 extending from top surface 135 of top plate 40 into upper threaded apertures 70 within bracket upper edges 180 of brackets 30. Alternatively, an attachment mechanism, which may or may not involve tools and/or fasteners, may be used between top plate 40 and brackets 30. Top plate 40, when attached to brackets 30, preferably suspends over rear fender 65 of the motorcycle.

In this embodiment, clamping blocks 160 and lock plate 20 are made integral with upright bars 120. However, because this configuration requires only a one-time adjustment/replacement of existing motorcycle hardware, after which luggage rack 45 will have the same flexibility and portability as the one illustrated in FIG. 1, this arrangement does not depart from the scope of the present invention.

Yet another embodiment of the present invention is shown in FIG. 6 and FIG. 7. This preferred embodiment is best suited for application to upright bars 120 that do not extend parallel relative to each other. As shown in FIG. 6, such upright bars 120 may diverge as they extend downwards. Referring to FIG. 6 and FIG. 7, luggage rack 45 preferably comprises top plate 40 and frame assembly 55. The frame assembly, according to one embodiment of this invention, preferably comprises lock plate 20, at least one bracket 30, at least one clamping block 160 and at least one block fastener 150. The frame assembly may further comprise at least one bracket fastener 140. According to one preferred embodiment of this invention, shown in FIG. 6 and FIG. 7, frame assembly comprises two clamping blocks 160, four block fasteners 150, two brackets 30 and four bracket fasteners 140.

According to one preferred embodiment of this invention, lock plate 20 is preferably positioned in between two upright bars 120, and the width of lock plate 20 preferably corresponds to the width of upright bars 120 so that lock plate 20 does not extend past seat side bar edges 210 and rear side bar edges 215 of upright bars 120. Clamping blocks 160 are preferably positioned against upright bars 120, one clamping block 160 against each upright bar 120. Each clamping block 160 preferably forms a U-shaped channel around upright bar 120 against which it is positioned. Open ends 165 of U-shaped clamping blocks 160 preferably extend past inside bar edges 125 of upright bars 120, and over a portion of lock plate 20 adjacent to upright bars 120; open ends 165 of each clamping block 160 preferably on opposite sides of lock plate 20. Clamping blocks 160 are preferably positioned with respect to lock plate 20 so that corresponding clamping block apertures 155 and lock plate apertures 10 align. Clamping blocks 160 are preferably coupled to lock plate 20 with block fasteners 150 that are preferably tightened into clamping block apertures 155 in open ends 165 of clamping blocks 160 and lock plate apertures 10 in lock plate 20. Since upright bars 120 may be positioned at an angle relative to vertical as shown in FIG. 6, clamping blocks 160 and/or lock plate side edges 25 of lock plate 20 may be positioned and/or shaped accordingly. Such design prevents frame assembly 55 from sliding downward along upright bars 120.

Like the previously described embodiments, brackets 30 are preferably removably attached with respect to lock plate 20. Brackets 30 are preferably removably secured to lock plate 20 with bracket fasteners 140. Bracket fasteners 140 preferably extend through lock plate 20, and are tightened into side threaded apertures 60 within bracket side edges 170 of brackets 30. Brackets 30, when attached to lock plate 20, preferably suspend over rear fender 65 of the motorcycle.

Top plate 40 may be removably secured to brackets 30 through top surface 135 of top plate 40 with plurality of top fasteners 80. Top fasteners 80 preferably extend through top surface 135 of top plate 40 and into bracket upper edges 180 of brackets 30. Top plate 40 may be attached to frame assembly 55 in a similar manner to the previously described embodiments, with or without tools and/or fasteners. Top plate 40, when attached to brackets 30, preferably suspends over rear fender 65 of the motorcycle.

According to a preferred embodiment of this invention, luggage rack 45 may have luggage rack cover 145 as illustrated in FIG. 9. Luggage rack cover 145 is used to protect the finish of top plate 40 which may be scratched or otherwise damaged by heavy and/or shifting loads. Luggage rack cover 145 may be made of leather or any other suitable material. Also, luggage rack cover 145 may include decorative designs and/or ornaments. In one preferred embodiment of this invention, luggage rack cover 145 is preferably made of leather and is preferably decorated with studs. In yet another preferred embodiment of this invention, luggage rack cover 145 is preferably made of “chrome-guard” leather which may provide special protection for chrome-finished luggage racks. Luggage rack cover 145 is preferably designed to fit around one or more top plates 40.

According to one preferred embodiment of this invention as illustrated in FIG. 9, luggage rack cover 145 preferably includes sheath 185, flap 195 and at least one cover fastener 175. Sheath 185 is preferably designed to fit around one or more top plates 40, and flap 195 is preferably designed to fold around top plate 40. Sheath 185 and flap 195 are preferably fastened with one or more cover fastener 175 or any other suitable manner.

While in the foregoing specification this invention has been described in relation to certain preferred embodiments thereof, and many details have been set forth for purpose of illustration, it will become apparent to those skilled in the art that the invention is susceptible to additional embodiments and that certain of the details described herein can be varied considerably without departing from the basic principles of the invention. Therefore, it is intended that the scope of the invention not be limited by the specification, but be defined by the claims set forth below.

I claim:

1. A luggage rack for mounting on a motorcycle, the luggage rack comprising:
a frame assembly mounted with respect to a seat of the motorcycle; and
a top plate removably attached to the frame assembly, the top plate interchangeable with at least one other top plate having a different configuration.

2. The luggage rack of claim 1, wherein the frame assembly comprises:
a cover plate positioned against upright bars of the seat;
at least one elongated fastener extending through the cover plate and the lock plate;
a lock plate positioned against the upright bars opposite the cover plate, the lock plate coupled to the cover plate with the at least one elongated fastener; and
at least one bracket removably attached with respect to the lock plate, the top plate removably attached to the at least one bracket.

3. The luggage rack of claim 1, wherein the top plate is one of a functional luggage carrier and a decorative motorcycle accessory.

4. The luggage rack of claim 2, wherein the at least one bracket matches an ornamental feature of the top plate.

5. The luggage rack of claim 2, wherein the at least one bracket further comprises at least one upper threaded aperture positioned in a bracket upper edge of the at least one bracket, the at least one upper threaded aperture lined with a stainless steel wire insert.

6. The luggage rack of claim 2, wherein the at least one bracket further comprises at least one side threaded aperture positioned in a bracket side edge of the at least one bracket, the at least one side threaded aperture lined with a stainless steel wire insert.

7. The luggage rack of claim 2, wherein the cover plate further comprises at least one cover plate aperture, the at least one cover plate aperture corresponding to at least one lock plate aperture within the lock plate.

8. The luggage rack of claim 2, wherein the top plate is removably secured to the at least one bracket through a top surface of the top plate.

9. The luggage rack of claim 8, wherein at least one top fastener extends through the top surface of the top plate into the bracket upper edge of the at least one bracket.

10. A luggage rack for mounting on a motorcycle, the luggage rack comprising:
a frame assembly mounted with respect to a seat of the motorcycle; and
a top plate removably attached to the frame assembly, the top plate interchangeable with at least one other top plate, the at least one other top plate having a distinct decorative feature from the top plate.

11. The luggage rack of claim 10, wherein the frame assembly comprises:
a cover plate positioned against upright bars extending upwards from the seat;
a lock plate positioned against the upright bars opposite the cover plate; and
at least one bracket removably attached with respect to the lock plate, the at least one bracket including a bracket upper edge and a bracket side edge, the at least one bracket having at least one upper threaded aperture within the bracket upper edge, the bracket having at least one side threaded aperture within the bracket side edge, wherein the top plate is removably attached with the at least one bracket.

12. The luggage rack of claim 10, wherein the frame assembly comprises:
a lock plate positioned against the upright bars;
at least one clamping block positioned against the upright bars with respect to the lock plate;
at least one bracket removably secured with respect to the lock plate, the top plate attachable to the at least one bracket; and
at least one block fastener connecting the lock plate and the at least one clamping block around the upright bars.

13. The luggage rack of claim 11, wherein the cover plate and the lock plate include a plurality of corresponding apertures.

14. The luggage rack of claim 11, wherein the at least one bracket is removably secured to the lock plate by one or more elongated fasteners extending from the lock plate into side threaded apertures within bracket side edges of the at least one bracket.

15. The luggage rack of claim 11, wherein the cover plate and the lock plate are positioned on opposite sides of the upright bars and are secured together by one or more elongated fasteners.

16. The luggage rack of claim 15, wherein a head of the one or more elongated fasteners is positioned on the seat side of the cover plate so that the one or more removable fasteners extend through the cover plate and the lock plate.

17. The luggage rack of claim 12, wherein the at least one bracket is removably secured to the lock plate by at least one bracket fastener extending from the lock plate into side threaded apertures within bracket side edges of the at least one bracket.

18. The luggage rack of claim 12, wherein the at least one clamping block forms a U-shaped channel around a corresponding upright bar, the U-shaped channel having an open end extending over the lock plate.

19. The luggage rack of claim 12, wherein at least a portion of the upright bars extend at an angle relative to vertical and the at least one clamping block is positioned at a corresponding angle.

20. The luggage rack of claim 10 further comprising a luggage rack cover that extends around the top plate.

21. A luggage rack for mounting to upright bars of a backrest of a motorcycle, the luggage rack comprising:
a cover plate positioned against the upright bars;
a lock plate positioned with respect to the cover plate;
at least one bracket removably attached with respect to the lock plate to maintain the cover plate and the lock plate in a fixed position relative to the upright bars; and
a top plate removably attached to the at least one bracket, the top plate interchangeable with at least one other top plate, the at least one other top plate having a distinct decorative feature from the top plate.

22. The luggage rack of claim 21, wherein the cover plate and the lock plate rest on top of sleeve upper edges of female sleeves that hold the upright bars in place.

23. The luggage rack of claim 21, wherein the cover plate includes cover plate side edges and the lock plate includes lock plate side edges that are each generally flush with outside bar edges of the upright bars.

24. The luggage rack of claim 21, wherein the lock plate has a thickness, a portion of the thickness milled away along lock plate side edges.

25. A luggage rack for mounting to upright bars of a motorcycle, the luggage rack comprising:
a lock plate positioned against the upright bars;
at least one clamping block positioned against the upright bars and connected to the lock plate;
at least one block fastener connecting the lock plate and the at least one clamping block together;
at least one bracket removably secured with respect to the lock plate;
at least one bracket fastener extending through the lock plate; and
a top plate removably attached to the at least one bracket, the top plate interchangeable with at least one other top plate, the at least one other top plate having a distinct decorative feature from the top plate.

26. The luggage rack of claim 25, wherein the at least one clamping block forms a U-shaped channel around the upright bar.

27. The luggage rack of claim 25, wherein the at least one clamping block is coupled to the lock plate with the at least one block fastener.

28. The luggage rack of claim 25, wherein the top plate has at least one of a Skull design, a Maltese Cross design, a Flame design, a T-Rack design and a Sport design.

29. The luggage rack of claim 25, wherein the luggage rack includes a luggage rack cover, the luggage rack cover comprising:
a sheath, the sheath designed to fit around the top plate;
a flap, the flap foldable around the top plate; and
at least one cover fastener fastening the flap to the sheath to maintain the luggage rack cover in a fixed position relative to the top plate.
